(19) United States
(12) Patent Application Publication
(10) Pub. No.: US 2011/0157054 A1
(43) Pub. Date: Jun. 30, 2011

(54) COMPUTING APPARATUS FOR RECOGNIZING TOUCH INPUT

(75) Inventors: Yoonseok CHANG, Seoul (KR); Changheun OH, Seoul (KR)

(73) Assignee: EXIS SOFTWARE ENGINEERING INC., Seoul (KR)

(21) Appl. No.: 12/977,606

(22) Filed: Dec. 23, 2010

(30) Foreign Application Priority Data
Dec. 29, 2009 (KR) 10-2009-0132964

(51) Int. Cl. G06F 3/041

(52) U.S. Cl. 345/173

(57) ABSTRACT

A computing apparatus for recognizing a touch input is disclosed. In accordance with the present invention, one or more objects and a space including the one or more objects displayed on a display device may be easily controlled by converting a touch of a first finger group and a touch of a second finger group into a predetermined command.

This application claims the benefit of Korean Patent Application No. 10-2009-0132964 filed on Dec. 29, 2009, which is hereby incorporated for reference.

### BACKGROUND OF THE INVENTION

1. Field of the Invention

The present invention relates to a computing apparatus for recognizing a touch input, and more particularly to a computing apparatus capable of detecting a touch of a first finger group and a touch of a second finger group and converting the same into a predetermined command.

The present invention is a result of a research as one of next generation new technology development project offered by Ministry of Knowledge Economy [Project no.: 10030102, Project name: Development of u-Green Logistics Solution and Service].

2. Description of the Related Art

A computing apparatus provides various user interfaces.

The computing apparatus provides representatively the user interface supporting a touch input, e.g., a touch of user's fingers as well as the user interface supporting a keyboard, a GUI (Graphic User Interface) supporting a mouse.

The user interface for recognizing the touch input is mainly applied to a portable device.

US2008/0122796 filed on Sep. 5, 2007 by Steven P. Jobs et al. and published on May 29, 2008, titled “TOUCH SCREEN DEVICE, METHOD, AND GRAPHICAL USER INTERFACE FOR DETERMINING COMMANDS BY APPLYING HEURISTICS” discloses a computing device for receiving one or more finger contacts using a touch screen display. Specifically, the disclosed computing device detects the one or more finger contacts and determines commands corresponding to the one or more finger contacts to convert images corresponding to the one or more finger contacts.

That is, while the computing device such as the portable device provides the user interface supporting the touch input, a conventional computing apparatus such as a personal computer may not provide the user interface supporting the touch input.

The conventional computing apparatus is required to provide means for receiving the touch input in order to provide the user interface supporting the touch input. However, the conventional computing apparatus providing the means is disadvantageous in that a manufacturing cost and a possibility of a malfunction increase.

The conventional computing apparatus provides, via mouse input, functions such as select, move, rotate, zoom in and zoom out of objects and spaces provided by an application program such as a CAD (Computer-Aided Design) for designing the spaces including the objects. Therefore, the user must apply the mouse input or a keyboard input by referring to a screen displayed on a display device connected to the conventional computing apparatus in order to use the function.

### SUMMARY OF THE INVENTION

It is an object of the present invention to provide a computing apparatus for recognizing a touch input capable of detecting a touch of a first finger group and a touch of a second finger group and converting the same into a predetermined command.

In order to achieve above-described object of the present invention, there is provided a computing apparatus connected to a display device and a touch recognition device mounted on the display device, the apparatus comprising: a memory, a program stored in the memory and a processor for executing the program, wherein the program comprises: a first instruction for detecting a touch of a first finger group and a touch of a second finger group applied on the touch recognition device; a second instruction for mapping the touch of the first finger group and the touch of the second finger group onto a first position information and a second position information of a screen displaying on the display device, respectively; and a third instruction for converting the touch of the first finger group and the touch of the second finger group into a predetermined command based on the first position information and the second position information.

The method in accordance with the present invention may further comprise.

Preferably, the display device displays on the screen a space comprising an area with objects including one or more objects and an area without objects other than the area with objects.

Preferably, the second position information corresponds to the area with objects on the screen, and the first position information corresponds to the area without objects on the screen.

Preferably, the second instruction comprises a first sub-instruction for mapping the touch of the first finger group onto the first position information and a second sub-instruction for mapping the touch of the second finger group onto the second position information when the first position information is constant, and the processor subjects the object corresponding to the second position information to the command converted by the third instruction.

Preferably, the command comprises one of select, rotate, move, zoom in and zoom out.

Preferably, the second instruction comprises a first sub-instruction for mapping the touch of the second finger group onto the second position information and a second sub-instruction for mapping the touch of the first finger group onto the first position information when the second position information is constant, and the processor subjects the object corresponding to the second position information to the command converted by the third instruction.

Preferably, the second sub-instruction and the third instruction are executed while the first sub-instruction is executed or after the first sub-instruction is executed.

Preferably, the command comprises one of select, rotate, move, zoom in and zoom out.

Preferably, the first position information and the second position information correspond to the area without objects on the screen.

Preferably, the second instruction comprises a first sub-instruction for mapping the touch of the first finger group onto the first position information and a second sub-instruction for mapping the touch of the second finger group onto the second position information when the first position information is constant, and the processor subjects the area with objects to the command converted by the third instruction based on the first position information.

Preferably, the second sub-instruction and the third instruction are executed while the first sub-instruction is executed or after the first sub-instruction is executed.

Preferably, the command comprises one of rotate, move, zoom in and zoom out.

Preferably, one or more objects are displayed in perspective view.

Preferably, the touches of the first finger group and the second finger group are applied on the touch recognition device by both hands of an user.

Preferably, the touch recognition device is integrated into the display device.

There is also provided a computer-readable medium having thereon a program carrying out a method for recognizing a touch input comprising: detecting a touch of a first finger group and a touch of a second finger group applied on a touch recognition device; mapping the touch of the first finger group and the touch of the second finger group onto a first position information and a second position information of a screen displayed on a display device, respectively; and converting the touch of the first finger group and the touch of the second finger group into a predetermined command based on the first position information and the second position information.

### BRIEF DESCRIPTION OF THE DRAWINGS

FIG. 1 is a block diagram illustrating a computing apparatus for recognizing a touch input in accordance with the present invention.

FIG. 2 is a block diagram illustrating a program included in a computing apparatus in accordance with the present invention.

FIG. 3 is a diagram illustrating an example of one or more objects displayed on the display device.

FIG. 4 is a diagram illustrating an example of selecting one or more objects in accordance with the present invention.

FIG. 5 is a diagram illustrating an example of moving or rotating one or more objects in accordance with the present invention.

FIG. 6 is a diagram illustrating an example of zooming-out or zooming-in one or more objects in accordance with the present invention.

FIG. 7 is a diagram illustrating an example of moving or rotating a space in accordance with the present invention.

FIG. 8 is a diagram illustrating an example of zooming-out or zooming-in a space in accordance with the present invention.

### DETAILED DESCRIPTION OF THE INVENTION

A computing apparatus for recognizing a touch input in accordance with the present invention will be described in detail with reference to accompanied drawings.

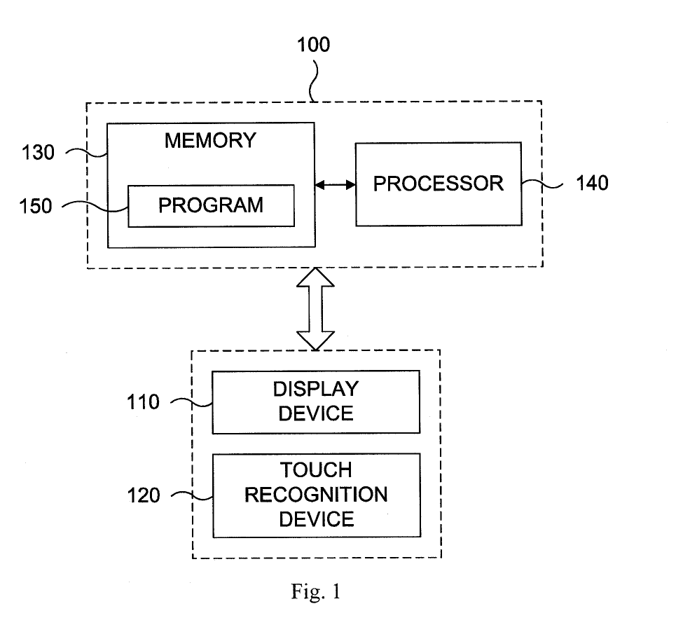

FIG. 1 is a block diagram illustrating a computing apparatus for recognizing a touch input in accordance with the present invention.

Referring to FIG. 1, a computing apparatus 100 in accordance with the present invention comprises a memory 130, a processor 140 and a program 150.

Preferably, the computing apparatus 100 in accordance with the present invention is connected to a display device 110 and a touch recognition device 120 so as to recognize a touch of a user's fingers applied to the touch recognition device 120.

The display device 110 and the touch recognition device 120 are described hereinafter in more detail prior to a description of the computing apparatus 100 in accordance with the present invention.

The display device 110 displays on a screen a space including one or more objects. For instance, the display device 110 may be an LCD monitor, an LCD TV or a PDP TV. Preferably, the display device 110 may be a large-screen LCD monitor used for a personal computer rather than a small-screen display used for a portable device.

FIG. 3 is a diagram illustrating an example of one or more objects displayed on the display device.

Referring to FIG. 3, a first object 210 through a third object 290 are displayed on a screen 200 displayed on the display device 110.

In the example shown in FIG. 3, the first object 210 through the third object 290 are a regular tetrahedron, a cylinder and a regular hexahedron, in perspective view, respectively.

The touch recognition device 120 recognizes the touch of the user's fingers.

Preferably, the touch recognition device 120 may be manufactured separately and mounted on the display device 110 by the user. The touch recognition device 120 mounted on the display device 110 recognizes the touch of the user's fingers and transmits the recognized touch of the user's fingers to the computing apparatus 100 in a form of electric signals.

In addition, the touch recognition device 120 may be integrated into the display device 110. The touch recognition device 120 integrated into the display device 110 recognizes the touch of the user's fingers and transmits the recognized touch of the user's fingers to the computing apparatus 100 in a form of electric signals.

The computing apparatus 100 in accordance with the present invention is described hereinafter in more detail.

The memory 130 stores the program 150. The memory 130 may be, but not limited to, a hard disk, a flask memory, a Ram, a ROM, a Blu-ray disk and a USB storage media.

The processor 140 executes the program 150 and controls components of the computing apparatus 100. Specifically, the processor 140 reads and executes the program 150 stored in the memory 130, and communicates with the display device 110 and the touch recognition device 120 according to a request for the program 150.

The program 150 is described hereinafter in more detail.

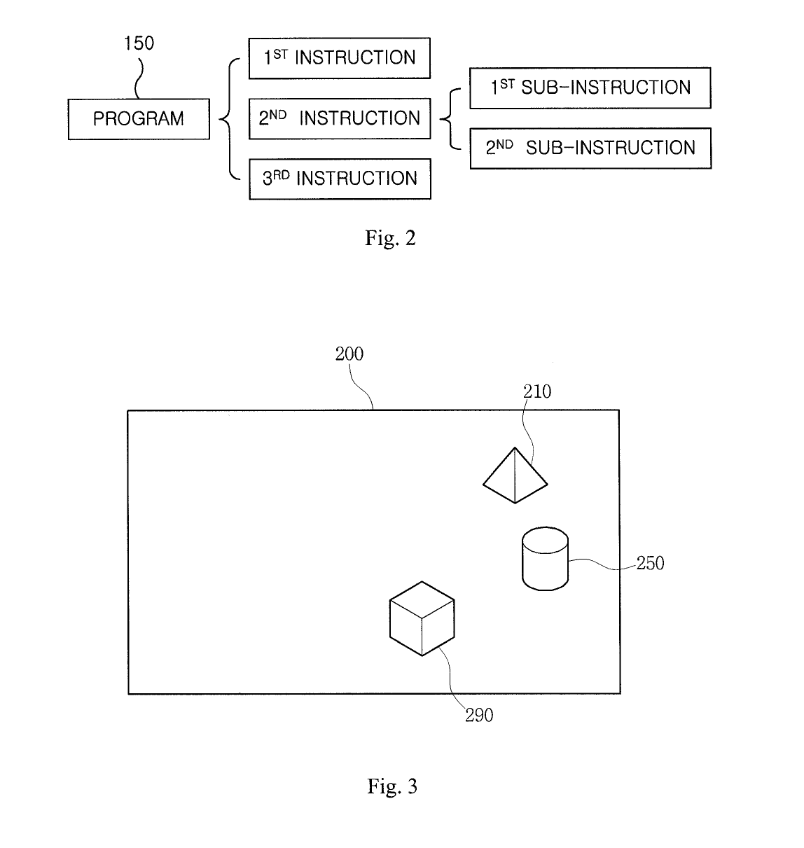

As shown in FIG. 2, the program 150 comprises a first instruction through a third instruction. Preferably, the second instruction may comprise include a first sub-instruction and a second sub-instruction.

The processor 140 detects, according to the first instruction, a touch of a first finger group and a touch of a second finger group applied on the touch recognition device 120.

The user may apply the touch of the first finger group and the touch of the second finger group on the touch recognition device 120 using one hand or both hands. For instance, the user may apply the touch of the first finger group and the touch of the second finger group on the touch recognition device 120 using fingers of the user's left hand and fingers of right hand, respectively, or sequentially apply the touch of the first finger group and the touch of the second finger group on the touch recognition device 120 using fingers of the user's right hand.

The processor 140 receives from the touch recognition device 120 in the form of electric signals and detects the touch of the first finger group and the touch of the second finger group applied by the user according to the first instruction. For instance, when the touch of the second finger group is applied on the touch recognition device 120 while applying the touch of the first finger group, the processor 140 may detect both the touch of the first finger group and the touch of the second finger group. Moreover, when the touch of the second finger group is applied on the touch recognition device 120 after the touch of the first finger group is applied onto and released from, the processor 140 may detect the touch of the first finger group and the touch of the second finger group applied sequentially.

The processor 140 maps, according to the second instruction, the touch of the first finger group and the touch of the second finger group onto a first position information and a second position information, respectively, and converts, according to the third instruction, the touch of the first finger group and the touch of the second finger group into a predetermined command based on the first position information and the second position information.

The display device 110 may display on the screen a space including an area with objects wherein the one or more objects are displayed and an area without objects.

The processor 140 executes the first instruction through the third instruction to interpret the touch of the first finger group and the touch of the second finger group applied onto the space displayed on the screen, i.e., the area with objects and the area without objects.

A process for executing the first instruction through the third instruction is described hereinafter in more detail.

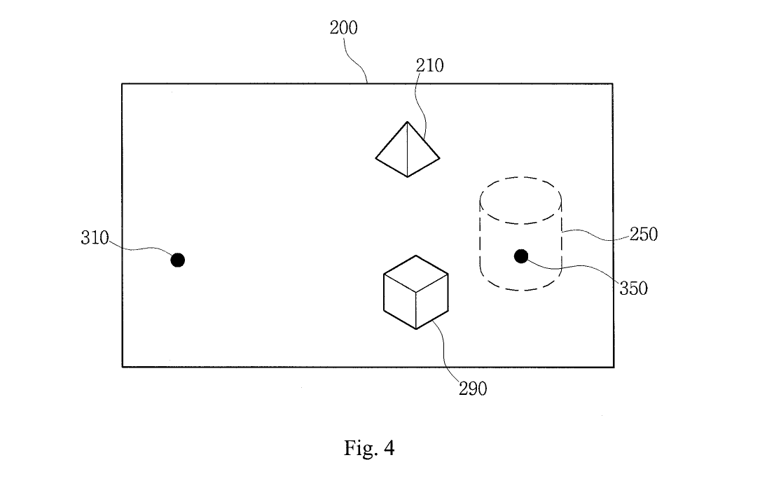

A first embodiment wherein the touch of the first finger group and the touch of the second finger group are applied onto the area without objects and the area with objects, respectively, is described below with reference to FIGS. 4 through 6.

In accordance with the first embodiment, the user applies the touch of the first finger group and the touch of the second finger group onto the area without objects and the area with objects, i.e., the second object area 250, respectively.

As shown in FIG. 4, when the touch of the first finger group and the touch of the second finger group are applied onto the area 310 without objects and the second object area 250, respectively, the processor 140 detects, according to the first instruction, the touch of the first finger group and the touch of the second finger group.

According to the first sub-instruction of the second instruction, the processor 140 maps the touch of the first finger group onto the first position information. According to the second sub-instruction of the second instruction, the processor 140 maps the touch of the second finger group onto the second position information. According to the third instruction, the processor 140 converts the touch of the first finger group and the touch of the second finger group into the predetermined command based on the first position information and the second position information. That is, as shown in FIG. 4, when the touch of the first finger group and the touch of the second finger group are applied onto the area 310 without objects and the area 350 with objects corresponding to the second object area 250, respectively, the processor 140 converts the touch of the first finger group and the touch of the second finger group into the predetermined command “select the second object 250”. The second object 250 shown in dotted lines in FIG. 4 may be then displayed through the screen 200 of the display device 110.

( [symbol] )

Similarly, when the user applies the touch of the second finger group onto more than two objects from among the first object 210 through the third object 290, i.e., the first object 210 and the second object 250, the processor 140 may convert the touch of the first finger group and the touch of the second finger group into the predetermined command “select the first object 210 and the second object 250” by executing the first instruction though the third instruction.

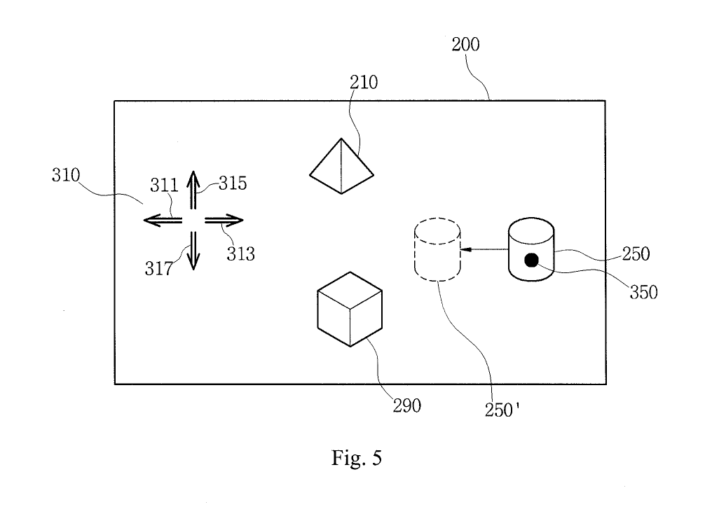

Moreover, as shown in FIG. 5, when the touch of the first finger group and the touch of the second finger group are applied onto the area 310 without objects and the second object area 250, respectively, the processor 140 detects, according to the first instruction, the touch of the first finger group and the touch of the second finger group. Preferably, the user may apply the touch of the first finger group onto the area 310 without objects after the touch of the first finger group is applied onto and released from the second object 250. More preferably, the touch of the first finger group may be applied onto the area 310 without objects in one of four directions, namely left 311, right 313, up 315 and down 317.

According to the first sub-instruction, the processor 140 maps the touch of the first finger group onto the second position information. According to the second sub-instruction, the processor 140 maps the touch of the second finger group onto the first position information. According to the third instruction, the processor 140 converts the touch of the first finger group and the touch of the second finger group into the predetermined command based on the first position information and the second position information. That is, as shown in FIG. 5, when the touch of the second finger group is applied onto the area 350 with objects corresponding to the second object area 250 and the touch of the first finger group is applied to the left 311, the processor 140 converts the touch of the first finger group and the touch of the second finger group into the predetermined command “move the second object 250 to the left”. The second object 250′ shown in dotted lines in FIG. 5, which is the second object 250 moved to the left 311, may be then displayed through the screen 200 of the display device 110.

Similarly, when the touch of the first finger group is applied in one of three directions, namely right 313, up 315 and down 317, the second object 250 may be moved or rotated according to the touch of the first finger group.

Preferably, the second object 250 may be moved proportional to a moving speed and a moving distance of the touch of the first finger group.

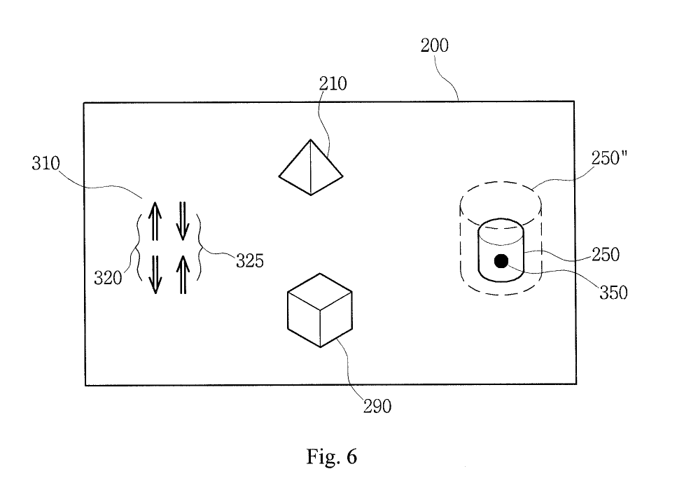

Moreover, as shown in FIG. 6, when the touch of the first finger group and the touch of the second finger group are applied onto the area 310 without objects and the second object area 250, respectively, the processor 140 detects, according to the first instruction, the touch of the first finger group and the touch of the second finger group. Preferably, the user may apply the touch of the first finger group onto the area 310 without objects after the touch of the first finger group is applied onto and released from the second object area 250. More preferably, the touch of the first finger group may be applied onto the area 310 without objects in a manner that two fingers included in the first finger group move in away from each other (direction 320 in FIG. 6) or toward each other (direction 325 in FIG. 6).

According to the first sub-instruction, the processor 140 maps the touch of the first finger group onto the second position information. According to the second sub-instruction, the processor 140 maps the touch of the second finger group onto the first position information. According to the third instruction, the processor 140 converts the touch of the first finger group and the touch of the second finger group into the predetermined command based on the first position information and the second position information. That is, as shown in FIG. 6, when the touch of the second finger group is applied onto the area 350 with objects corresponding to the second object area 250 and touch of the first finger group is applied to the direction 320, the processor 140 converts the touch of the first finger group and the touch of the second finger group into the predetermined command “zoom in the second object 250”. The second object 250″ shown in dotted lines in FIG. 6, which is zoomed in the second object 250, may be then displayed through the screen 200 of the display device 110.

Similarly, when the touch of the first finger group is applied to the direction 325, the second object 250 may be zoomed out according to the touch of the first finger group.

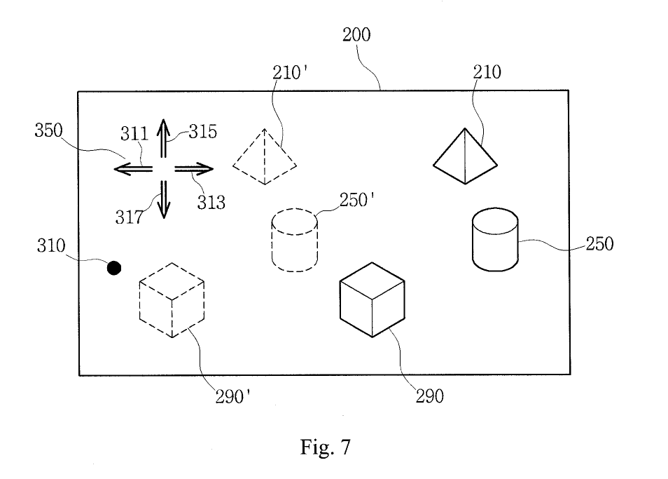

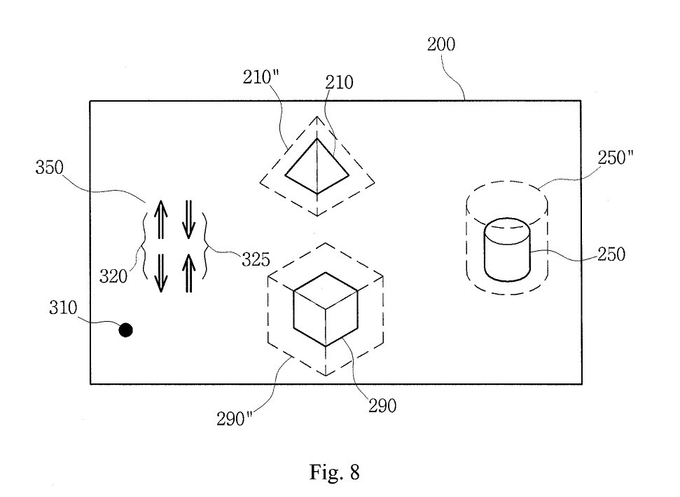

A second embodiment wherein both the touch of the first finger group and the touch of the second finger group are applied onto the area without objects is described below with reference to FIGS. 7 and 8.

In accordance with the second embodiment, the user applies the first finger group and the touch of the second finger group are applied onto the area 350 without objects and the area 310 without objects, respectively.

As shown in FIG. 7, when the touch of the first finger group and the touch of the second finger group are applied onto the area 350 without objects and the area 310 without objects, respectively, the processor 140 detects, according to the first instruction, the touch of the first finger group and the touch of the second finger group. Preferably, the user may apply the touch of the first finger group onto the area 350 without objects after the touch of the first finger group is applied onto and released from the area 310 without objects. More preferably, the touch of the first finger group may be applied onto the area 350 without objects in one of four directions, namely left 311, right 313, up 315 and down 317.

According to the first sub-instruction, the processor 140 maps the touch of the first finger group onto the first position information. According to the second sub-instruction, the processor 140 maps the touch of the second finger group onto the second position information. According to the third instruction, the processor 140 converts the touch of the first finger group and the touch of the second finger group into the predetermined command based on the first position information and the second position information. That is, as shown in FIG. 7, when the touch of the second finger group is applied onto the area 310 without objects and the touch of the first finger group is applied to the left 311, the processor 140 may convert the touch of the first finger group and the touch of the second finger group into the predetermined command “move the area 310 without objects to the left”. Therefore, the area 310 without objects, i.e., the first object 210 through the third object 290 included in the space is moved to the left 311. The first object 210′ through the third object 290′ shown in dotted lines in FIG. 7, which are the first object 210 through the third object 290 moved to the left 311, may be then displayed through the screen 200 of the display device 110.

Similarly, when the touch of the first finger group is applied in one of three directions, namely right 313, up 315 and down 317, are the first object 210 through the third object 290 may be moved or rotated according to the touch of the first finger group.

Preferably, the first object 210 through the third object 290 may be moved proportional to the moving speed and the moving distance of the touch of the first finger group.

Moreover, as shown in FIG. 8, when the touch of the first finger group and the touch of the second finger group are applied onto the area 350 without objects and the area 310 without objects, respectively, the processor 140 detects, according to the first instruction, the touch of the first finger group and the touch of the second finger group. Preferably, the user may apply the touch of the first finger group onto the area 350 without objects after the touch of the first finger group is applied onto and released from the area 310 without objects. More preferably, the touch of the first finger group may be applied onto the area 310 without objects in a manner that two fingers included in the first finger group move in away from each other (direction 320 in FIG. 8) or toward each other (direction 325 in FIG. 8).

According to the first sub-instruction, the processor 140 maps the touch of the first finger group onto the first position information. According to the second sub-instruction, the processor 140 maps the touch of the second finger group onto the second position information. According to the third instruction, the processor 140 converts the touch of the first finger group and the touch of the second finger group into the predetermined command based on the first position information and the second position information. That is, as shown in FIG. 8, when the touch of the second finger group is applied onto the area 310 without objects and the touch of the first finger group is applied to the direction 320, the processor 140 converts the touch of the first finger group and the touch of the second finger group into the predetermined command “zoom in the area 310 without”. Therefore, the area 310 without objects, i.e., the first object 210 through the third object 290 included in the space is zoomed in. The first object 210″ through the third object 290″ shown in dotted lines in FIG. 8, which are zoomed in the first object 210 through the third object 290, may be then displayed through the screen 200 of the display device 110.

Similarly, the touch of the first finger group is applied to the direction 325, the first object 210 through the third object 290 may be zoomed out according to the touch of the first finger group.

In addition, the present invention provides a computer-readable medium having thereon a program carrying out the method for recognizing the touch input described above.

The computer-readable medium refers to various storage mediums for storing a data in a code or a program format that may be read by a computer system. The computer-readable medium may include a memory such as a Rom and a Ram, a storage medium such as CD-ROM and a DVD-ROM, a magnetic storage medium such as a magnetic tape and a floppy disk, and am optical data storage medium. The computer-readable medium may include a data transferred via the Internet. The computer-readable medium may be embodied by a computer-readable data divided and stored over computer systems connected through a network.

Since the computer-readable medium in accordance with the present invention is substantially identical to that of the program included in the computing apparatus for recognizing the touch input in accordance with the present invention described with reference to FIGS. 4 though 8, a detailed description thereof is omitted.

In accordance with the present invention, since the touch of the first finger group and the touch of the second finger group are detected and converted into the predetermined command a selection, a rotation, a movement, a zoom in and a zoom out of the one or more objects displayed on the display device are facilitated. In addition, the touch of the first finger group and the touch of the second finger group are detected and converted into the predetermined command a selection, a rotation, a movement, a zoom in and a zoom out of the space including the one or more objects displayed on the display device are facilitated.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is:

1. A computing apparatus connected to a display device and a touch recognition device mounted on the display device, the apparatus comprising:
a memory, a program stored in the memory and a processor for executing the program, wherein the program comprises:
a first instruction for detecting a touch of a first finger group and a touch of a second finger group applied on the touch recognition device;
a second instruction for mapping the touch of the first finger group and the touch of the second finger group onto a first position information and a second position information of a screen displaying on the display device, respectively; and
a third instruction for converting the touch of the first finger group and the touch of the second finger group into a predetermined command based on the first position information and the second position information.

2. The computing apparatus in accordance with claim 1, wherein the display device displays on the screen a space comprising an area with objects including one or more objects and an area without objects other than the area with objects.

3. The computing apparatus in accordance with claim 2, wherein the second position information corresponds to the area with objects on the screen, and
the first position information corresponds to the area without objects on the screen.

4. The computing apparatus in accordance with claim 3, wherein the second instruction comprises a first sub-instruction for mapping the touch of the first finger group onto the first position information and a second sub-instruction for mapping the touch of the second finger group onto the second position information when the first position information is constant, and
the processor subjects the object corresponding to the second position information to the command converted by the third instruction.

5. The computing apparatus in accordance with claim 4, wherein the command comprises one of select, rotate, move, zoom in and zoom out.

6. The computing apparatus in accordance with claim 3, wherein the second instruction comprises a first sub-instruction for mapping the touch of the second finger group onto the second position information and a second sub-instruction for mapping the touch of the first finger group onto the first position information when the second position information is constant, and
the processor subjects the object corresponding to the second position information to the command converted by the third instruction.

7. The computing apparatus in accordance with claim 6, wherein the second sub-instruction and the third instruction are executed while the first sub-instruction is executed or after the first sub-instruction is executed.

8. The computing apparatus in accordance with claim 7, wherein the command comprises one of select, rotate, move, zoom in and zoom out.

9. The computing apparatus in accordance with claim 2, wherein the first position information and the second position information correspond to the area without objects on the screen.

10. The computing apparatus in accordance with claim 9, wherein the second instruction comprises a first sub-instruction for mapping the touch of the first finger group onto the first position information and a second sub-instruction for mapping the touch of the second finger group onto the second position information when the first position information is constant, and
the processor subjects the area with objects to the command converted by the third instruction based on the first position information.

11. The computing apparatus in accordance with claim 10, wherein the second sub-instruction and the third instruction are executed while the first sub-instruction is executed or after the first sub-instruction is executed.

12. The computing apparatus in accordance with claim 11, wherein the command comprises one of rotate, move, zoom in and zoom out.

13. The computing apparatus in accordance with claim 2, wherein one or more objects are displayed in perspective view.

14. The computing apparatus in accordance with claim 1, wherein the touches of the first finger group and the second finger group are applied on the touch recognition device by both hands of an user.

15. The computing apparatus in accordance with claim 1, wherein the touch recognition device is integrated into the display device.

16. A computer-readable medium having thereon a program carrying out a method for recognizing a touch input comprising:
detecting a touch of a first finger group and a touch of a second finger group applied on a touch recognition device;
mapping the touch of the first finger group and the touch of the second finger group onto a first position information and a second position information of a screen displayed on a display device, respectively; and
converting the touch of the first finger group and the touch of the second finger group into a predetermined command based on the first position information and the second position information.
